(19) United States
(12) Patent Application Publication
(10) Pub. No.: US 2021/0099370 A1
(43) Pub. Date: Apr. 1, 2021

(54) METHOD OF MONITORING LIDAR CONNECTION STATUS, LIDAR, AND HOST COMPUTER

(71) Applicant: SZ DJI TECHNOLOGY CO., LTD., Shenzhen (CN)

(72) Inventors: Chenghui LONG, Shenzhen (CN); Tao LI, Shenzhen (CN)

(21) Appl. No.: 17/118,514

(22) Filed: Dec. 10, 2020

Related U.S. Application Data
(63) Continuation of application No. PCT/CN2018/092565, filed on Jun. 25, 2018.

(51) Int. Cl. H04L 12/26; G01S 17/10; G01S 7/481; G01S 7/4865

(52) U.S. Cl. CPC H04L 43/0811; H04L 43/10; G01S 7/4865; G01S 7/4817; G01S 17/10

(57) ABSTRACT

A method of monitoring a connection status of a LIDAR includes receiving address information and port identification of a host computer transmitted by the host computer, transmitting a connection confirmation message to the host computer, transmitting a data packet to the host computer according to the address information and the port identification of the host computer, and determining whether the connection between the LIDAR and the host computer is normal through a heartbeat packet or a heartbeat return packet. The connection confirmation message is used to indicate that the connection between the LIDAR and the host computer is established successfully.

### CROSS-REFERENCE TO RELATED APPLICATION

This application is a continuation of International Application No. PCT/CN2018/092565, filed Jun. 25, 2018, the entire content of which is incorporated herein by reference.

### TECHNICAL FIELD

The present disclosure generally relates to the LIDAR technology field and, more particularly, to a method of monitoring a LIDAR connection status, a LIDAR, and a host computer.

### BACKGROUND

Currently, LIDAR is usually connected to an Ethernet and uses a user datagram protocol (UDP) for communication. The UDP is a communication method, which is highly efficient but not reliable. A data transmission terminal cannot know whether data is normally received.

In the existing technology, when transmitting a data packet to a host computer, the LIDAR broadcasts the data packet to all the host computers in a local area network (LAN) in a broadcasting manner, such that the host computer obtains the data packet broadcasted by the LIDAR. However, during transmission of the data packet, both the LIDAR and the host computer do not monitor whether their corresponding devices operate normally. Therefore, both the LIDAR and the host computer cannot determine whether the connection statuses of the corresponding devices are normal.

### SUMMARY

Embodiments of the present disclosure provide a method of monitoring a connection status of a LIDAR. The method includes receiving address information and port identification of a host computer transmitted by the host computer, transmitting a connection confirmation message to the host computer, transmitting a data packet to the host computer according to the address information and the port identification of the host computer, and determining whether the connection between the LIDAR and the host computer is normal through a heartbeat packet or a heartbeat return packet. The connection confirmation message is used to indicate that a connection between the LIDAR and the host computer is established successfully.

Embodiments of the present disclosure provide a LIDAR including a receiver, a transmitter, and a processor. The receiver is configured to receive address information and port identification of a host computer transmitted by the host computer. The transmitter is configured to transmit a connection confirmation message to the host computer and transmit a data packet to the host computer according to the address information and the port identification of the host computer. The connection confirmation message is used to indicate that a connection between a LIDAR and the host computer is established successfully. The processor is configured to determine whether the connection between the LIDAR and the host computer is normal through a heartbeat packet or a heartbeat return packet.

### BRIEF DESCRIPTION OF THE DRAWINGS

FIG. 1 is a schematic structural diagram of a LIDAR according to some embodiments of the present disclosure.

FIG. 2 is a schematic diagram showing a method of monitoring a LIDAR connection status according to some embodiments of the present disclosure.

FIG. 3 is a schematic diagram showing another method of monitoring a LIDAR connection status according to some embodiments of the present disclosure.

FIG. 4 is a schematic diagram showing a method of determining whether a connection between the LIDAR and a host computer is normal through a heartbeat packet or a heartbeat return packet according to some embodiments of the present disclosure.

FIG. 5 is a schematic diagram showing another method of determining whether the connection between the LIDAR and the host computer is normal through the heartbeat packet or the heartbeat return packet according to some embodiments of the present disclosure.

FIG. 6 is a schematic structural diagram of a LIDAR according to some embodiments of the present disclosure.

FIG. 7 is a schematic structural diagram of a host computer according to some embodiments of the present disclosure.

### DETAILED DESCRIPTION OF THE EMBODIMENTS

To make the purpose, the technical solution, and the advantage of embodiments of the present disclosure clearer, the technical solution of embodiments of the present disclosure is described in detail in connection with the accompanying drawings. Described embodiments are some embodiments of the present disclosure, not all embodiments. Based on embodiments of the present disclosure, all other embodiments obtained by those of ordinary skill in the art without creative efforts are within the scope of the present disclosure. When there is no conflict, embodiments and features of embodiments may be combined with each other.

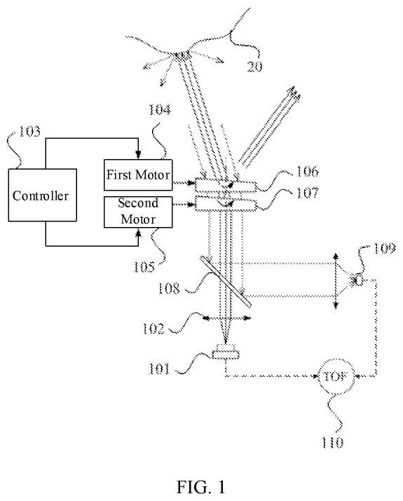

A method of monitoring a LIDAR connection status consistent with embodiments of the present disclosure may be applied to a LIDAR. For example, FIG. 1 is a schematic structural diagram of the LIDAR according to some embodiments of the present disclosure. The LIDAR includes a laser device 101, a lens 102, a controller 103, a first motor 104, a second motor 105, a first prism 106, a second prim 107, a beam splitter 108, a receiver 109, and a time of flight (TOF) circuit 110. The receiver 109 may include a photodiode, for example, an avalanche photo diode (APD). For example, when the LIDAR is used to detect a distance to a target 20, the laser device 101 of the LIDAR may change an electrical pulse signal into a divergent light pulse signal. The lens 102 may change the divergent light pulse signal into a parallel light pulse signal to send out. The controller 103 (e.g., arranged in a chip) may control a rotation of the first prism 106 through the first motor 104, control a rotation of the second prism 107 through the second motor 105, and use a differential rotation of the first prism 106 and the second prism 107 to change a direction of a light pulse signal emitted after passing through the first prism 106 and the second prism 107. After the emitted light pulse signal hits the target 20, the light pulse signal may be reflected. The reflected pulse signal may be split by the beam splitter 108 and enter the receiver 109 (including APD). The receiver 109 may convert the light pulse signal into an electrical pulse signal. The distance between the LIDAR and the target may be calculated by the TOF circuit 110 (e.g., arranged in a chip). When the LIDAR detects the distance to the target, the LIDAR may need to transmit a distance data packet to the host computer. Thus, the host computer obtains distance information of the target 20. According to the above, how to monitor the connection status of the LIDAR and the host computer is very important during data packet transmission.

In embodiments of the present disclosure, the technical solution and how the technical solution of embodiments of the present disclosure solving the above technical problem is described in detail. Embodiments of the present disclosure may be combined with each other. Same or similar principles or processes are not repeated in some embodiments. Embodiments of the present disclosure are described in connection with the accompanying drawings.

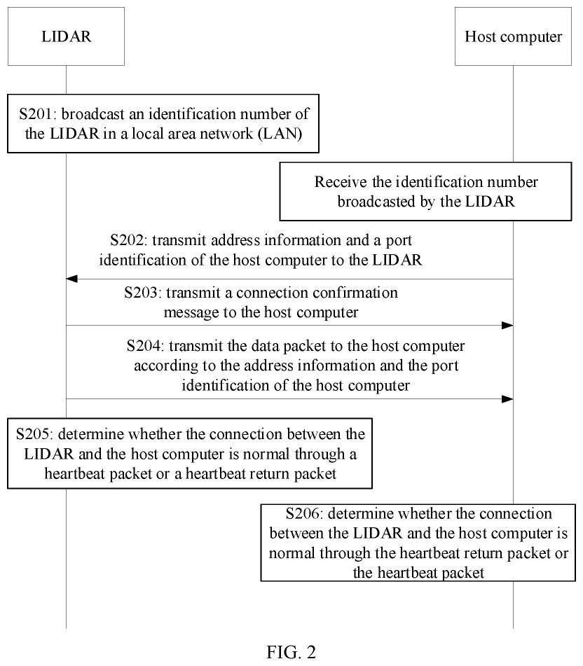

FIG. 2 is a schematic diagram showing a method of monitoring a LIDAR connection status according to some embodiments of the present disclosure. As shown in FIG. 2, the method of monitoring the LIDAR connection status includes the following processes.

At S201, the LIDAR broadcasts an identification number of the LIDAR in a local area network (LAN).

The identification number has a one-to-one correspondence with the LIDAR. That is, the identification number may uniquely identify the LIDAR. For example, the identification number of the LIDAR may include a product serial number (SN) of the LIDAR, or an identification of the LIDAR, as long as they can be used to identify the LIDAR and have the one-to-one correspondence with the LIDAR.

After being powered on, the LIDAR may broadcast its own identification number to all host computers in the LAN, such that the corresponding host computer in the LAN may receive the identification number of the LIDAR. After receiving the identification number of the LIDAR broadcasted by the LIDAR in the LAN, the host computer executes process S202.

At S202, the host computer transmits address information and a port identification of the host computer to the LIDAR.

The address information and the port identification of the host computer may be transmitted after the host computer obtains the identification number of the LIDAR. The host computer may include a terminal device having a communication capability. For example, the host computer may include a terminal device of a cellphone, a tablet computer, etc. In addition, the address information may include internet protocol (IP) address information. The port identification may be used to identify a port of the host computer that receives data.

After receiving the identification number of the LIDAR at S201, the host computer may reply to the LIDAR with the address information and the data reception port of the host computer. Thus, after receiving the address information and the port identification of the host computer transmitted by the host computer, the LIDAR executes process S203.

At S203, the LIDAR transmits a connection confirmation message to the host computer.

The connection confirmation message may include an acknowledgment (ACK), which may be used to identify that the LIDAR and the host computer are successfully connected.

After receiving the address information and the port identification of the host computer at S202, the LIDAR may transmit the connection confirmation message to the host computer, such that the host computer may determine that the LIDAR and the host computer are successfully connected according to the connection confirmation message.

At S204, the LIDAR transmits the data packet to the host computer according to the address information and the port identification of the host computer.

After the LIDAR and the host computer are connected, the LIDAR may transmit the data packet to the host computer according to the address information and the port identification of the host computer transmitted by the host computer. As such, the host computer may receive the data packet transmitted by the LIDAR to realize the data transmission between the LIDAR and the host computer.

At S205, the LIDAR determines whether the connection between the LIDAR and the host computer is normal through a heartbeat packet or a heartbeat return packet.

At S206, the host computer determines whether the connection between the LIDAR and the host computer is normal through the heartbeat return packet or the heartbeat packet.

In embodiments of the present disclosure, both the LIDAR and the host computer may determine whether the connection between the LIDAR and the host computer is normal by two possible implementations of the heartbeat packet or the heartbeat return packet. In some embodiments, when the LIDAR determines whether the connection between the LIDAR and the host computer is normal through the heartbeat packet, correspondingly, the host computer may determine whether the connection between the LIDAR and the host computer is normal through the heartbeat return packet. When the LIDAR determines whether the connection between the LIDAR and the host computer is normal through the heartbeat return packet, correspondingly, the host computer may determine whether the connection between the LIDAR and the host computer is normal through the heartbeat packet. As such, the data transmission is determined whether to continue.

In addition, in the disclosure, no order exists between process S205 and process S206. Process S205 may be executed first, and then process S206 may be executed, or process S206 may be executed first, and then process S205 may be executed, or process S205 and process S206 may be executed simultaneously. In embodiments of the present disclosure, process S205 being executed first and then process S206 being executed is described as an example only. However, embodiments of the present disclosure are not limited to this.

In the method of monitoring the LIDAR connection status consistent with embodiments of the present disclosure, after receiving the identification number broadcasted by the LIDAR, the host computer may transmit the address information and the port identification of the host computer to the LIDAR. Thus, after receiving the address information and the port identification of the host computer, the LIDAR may transmit the connection confirmation message identifying the successful connection to the host computer. Then, the LIDAR may transmit the data packet to the host computer according to the address information and the port identification of the host computer to realize the data transmission between the LIDAR and the host computer. In addition, after the LIDAR transmits the data packet to the host computer according to the address information and the port identification of the host computer, the LIDAR may determine whether the connection between the LIDAR and the host computer is normal through the heartbeat packet or the heartbeat return packet, and the host computer may determine whether the connection between the LIDAR and the host computer is normal through the heartbeat return packet or heartbeat packet to determine whether to continue with the data transmission. Therefore, the connection status of the LIDAR and the host computer may be monitored during the data transmission.

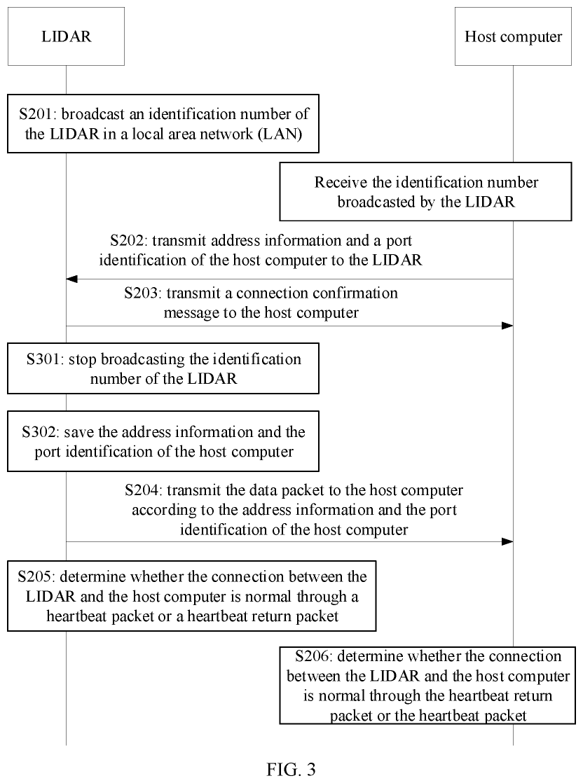

FIG. 3 is a schematic diagram showing another method of monitoring a LIDAR connection status according to some embodiments of the present disclosure. In some embodiments, after the host computer transmits the address information and the port identification of the host computer to the LIDAR to cause the LIDAR to receive the address information and the port identification of the host computer transmitted by the host computer at S202, the method of monitoring the LIDAR connection status includes the following processes.

At S301, the LIDAR stops broadcasting the identification number of the LIDAR.

After being powered on, the LIDAR may broadcast its own identification number to the host computers in the LAN. In embodiments of the present disclosure, when broadcasting its own identification number, the LIDAR may not always in an identification number broadcasting status. After determining the successful connection between the LIDAR and the host computer according to the address information and the port identification of the host computer, the LIDAR may stop broadcasting its own identification number to effectively avoid data congestion caused by excessive broadcasting data in the LAN.

In addition, after the host computer transmits the address information and the port identification of the host computer to the LIDAR at S202 to cause the LIDAR to receive the address information and the port identification of the host computer transmitted by the host computer, the method of monitoring the LIDAR connection status further includes the following processes.

At S302, the address information and the port identification of the host computer are saved.

After receiving the address information and the port identification of the host computer transmitted by the host computer, the LIDAR may save the address information and the port identification of the host computer. As such, the address information and the port identification of the host computer may be subsequently obtained directly by looking them up, and the LIDAR and the host computer may not need to be connected to obtain the address information and the port identification of the host computer. Thus, the data packet may be transmitted to the host computer according to the address information and the port identification of the host computer.

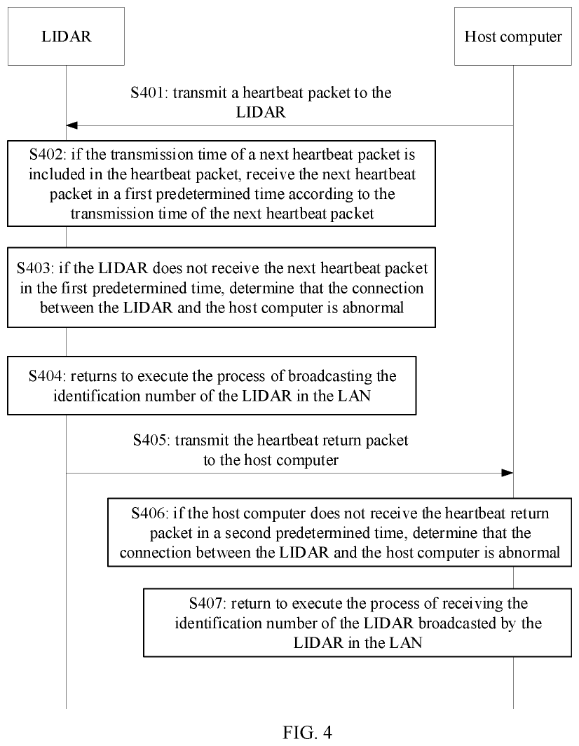

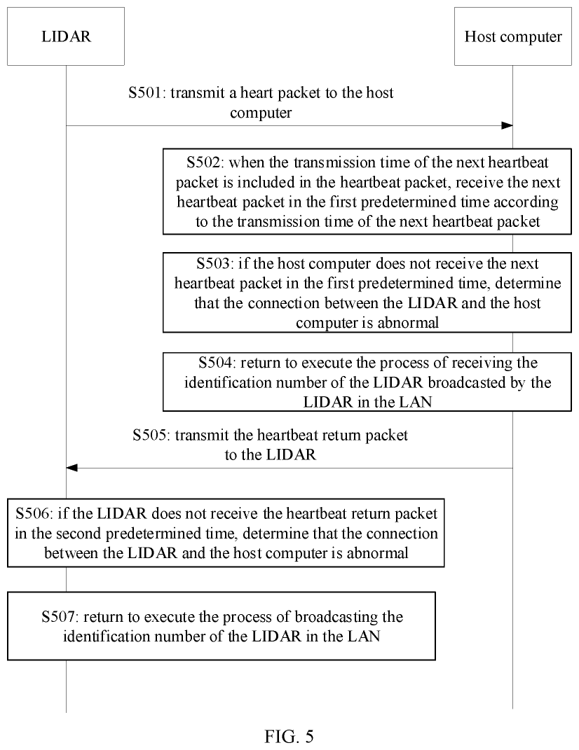

Process S205 and process S206 of determining whether the connection between the LIDAR and the host computer is normal by the two possible implementations using the heartbeat packet or the heartbeat return packet are described in detail below in connection with FIG. 4 and FIG. 5. For example, in embodiments shown in FIG. 4, process S205 and process S206 may be replaced by processes S401 to S407. In embodiments shown in FIG. 5, process S205 and process S206 may be replaced by processes S501 to S507.

FIG. 4 is a schematic diagram showing a method of determining whether a connection between the LIDAR and a host computer is normal through a heartbeat packet or a heartbeat return packet according to some embodiments of the present disclosure. Based on embodiments shown in FIG. 2 or FIG. 3, when the LIDAR determines whether the connection between the LIDAR and the host computer is normal through the heartbeat packet, and the host computer determines whether the connection between the LIDAR and the host computer is normal through the heartbeat return packet, the m-ethod includes the following processes.

At S401, the host computer transmits a heartbeat packet to the LIDAR.

When determining whether the connection between the LIDAR and the host computer is normal, the host computer may transmit the heartbeat packet to the LIDAR. As such, after receiving the heartbeat packet transmitted by the host computer, the LIDAR may determine whether the connection between the LIDAR and the host computer is normal according to the heartbeat packet.

At S402, if the transmission time of a next heartbeat packet is included in the heartbeat packet, the LIDAR receives the next heartbeat packet in a first predetermined time according to the transmission time of the next heartbeat packet.

The transmission time of the next heartbeat packet included in the heartbeat packet may be represented by two manners. For one manner, the transmission time of the next heartbeat packet may be directly the time that the host computer transmits the next heartbeat packet. For the other manner, the transmission time of the next heartbeat packet may be a time interval between the time that the host computer transmits the next heartbeat packet and the time the host computer transmits the current heartbeat packet. Thus, the transmission time of the next heartbeat packet may be determined according to the time interval between the time that the host computer transmits the next heartbeat packet and the time the host computer transmits the current heartbeat packet.

The first predetermined time may be set according to the transmission time of the next heartbeat packet. For example, when the transmission time of the next heartbeat packet is represented by the time interval between the time that the host computer transmits the next heartbeat packet and the time that the host computer transmits the current heartbeat packet. When the time interval is 2 seconds, the first predetermined time may be set to 2.1 seconds, 2.2 seconds, 2.3 seconds, . . . , 4.9 seconds, or 5.0 seconds, which are examples used to describe embodiments of the present disclosure. What the first predetermined time being set is not further limited by embodiments of the present disclosure.

At S403, if the LIDAR does not receive the next heartbeat packet in the first predetermined time, the LIDAR determines that the connection between the LIDAR and the host computer is abnormal.

In embodiments of the present disclosure, if the LIDAR does not receive the next heartbeat packet in the first predetermined time, the connection between the LIDAR and the host computer is abnormal. On the contrary, if the LIDAR receives the next heartbeat packet in the first predetermined time, the connection between the LIDAR and the host computer is normal.

In some embodiments, after determining that the connection between the LIDAR and the host computer is abnormal at S403, the method further includes the following process.

At S404, the LIDAR returns to execute the process of broadcasting the identification number of the LIDAR in the LAN.

When determining that the connection between the LIDAR and the host computer is abnormal, the LIDAR may determine that the connection to the host computer is disconnected. At this point, the LIDAR may enter a low power consumption mode and return to execute process S201 of broadcasting the identification number of the LIDAR in the LAN to try to re-establish the connection to the host computer.

Processes S401 to S404 describe how the LIDAR determines whether the connection between the LIDAR and the host computer is normal according to the heartbeat packet transmitted by the host computer. Correspondingly, after receiving the heartbeat packet transmitted by the host computer, the LIDAR may transmit the heartbeat return packet to the host computer, such that the host computer may determine whether the connection between the LIDAR and the host computer is normal according to the heartbeat return packet transmitted by the LIDAR with reference to following processes S405 to S407.

At S405, the LIDAR transmits the heartbeat return packet to the host computer.

In embodiments of the present disclosure, no sequence exists between processes S402 to S404 and process S405. Processes S402 to S404 may be executed first, and then process S405 may be executed, or process S405 may be executed first, and then processes S402 to S404 may be executed, or processes S402 to S404 and process S405 may be executed simultaneously. In embodiments of the present disclosure, only the example of processes S402 to S404 being executed first and then process S405 being executed is described. However, embodiments of the present disclosure are not limited to this.

After receiving the heartbeat packet transmitted by the host computer, the LIDAR may transmit the corresponding heartbeat return packet to the host computer. As such, after receiving the heartbeat return packet transmitted by the LIDAR, the host computer may determine whether the connection between the LIDAR and the host computer is normal.

At S406, if the host computer does not receive the heartbeat return packet in a second predetermined time, the host computer determines that the connection between the LIDAR and the host computer is abnormal.

The second predetermined time may be set in different manners. For example, when the time interval that the host computer transmits the heartbeat packet is two seconds, the second predetermined time may be set to 1.0 second, 1.1 seconds, 1.2 seconds, . . . , 4.9 seconds, or 5.0 seconds, which are described as examples in embodiments of the present disclosure. What the second predetermined time being set is not further limited by embodiments of the present disclosure.

In embodiments of the present disclosure, if the host computer does not receive the heartbeat return packet in the second predetermined time, the connection between the LIDAR and the host computer is abnormal. On the contrary, if the host computer receives the heartbeat return packet, the connection between the LIDAR and the host computer is normal.

When a time interval of reception time of the heartbeat packet and reception time of a last heartbeat packet is included in the heartbeat packet, the host computer may further determine whether a lost packet occurs according to the time interval of the reception time of the heartbeat packet and the reception time of the last heartbeat packet.

After determining that the connection between the LIDAR and the host computer is abnormal at S406, the method further includes the following process.

At S407, the host computer returns to execute the process of receiving the identification number of the LIDAR broadcasted by the LIDAR in the LAN.

When determining that the connection between the LIDAR and the host computer is abnormal, the LIDAR may determine that the connection to the host computer is disconnected. At this point, the LIDAR may enter the low power consumption mode and return to execute process S201 of broadcasting the identification number of the LIDAR in the LAN. Correspondingly, the host computer may also return to execute the process of receiving the identification number of the LIDAR broadcasted by the LIDAR in the LAN to try to re-establish the connection to the host computer. Therefore, the LIDAR may determine whether the connection between the LIDAR and the host computer is normal through the heartbeat packet during the data transmission, and the host computer may determine whether the connection between the LIDAR and the host computer is normal through the heartbeat return packet, so as to monitor the connection status of the LIDAR and the host computer.

As shown in FIG. 4, embodiments of the present disclosure describe the technical solution of how the LIDAR determines whether the connection between the LIDAR and the host computer is normal through the heartbeat packet, and how the host computer determines whether the connection between the LIDAR and the host computer is normal through the heartbeat return packet. FIG. 5 is a schematic diagram showing another method of determining whether the connection between the LIDAR and the host computer is normal through the heartbeat packet or the heartbeat return packet according to some embodiments of the present disclosure. The following technical solution is described in detail, when the LIDAR determines whether the connection between the LIDAR and the host computer is normal through the heartbeat return packet, and the host computer determines whether the connection between the LIDAR and the host computer is normal through the heartbeat packet. As shown in FIG. 5, the method further includes the following processes.

At S501, the LIDAR transmits a heart packet to the host computer.

When determining whether the connection between the LIDAR and the host computer is normal, the LIDAR may transmit the heartbeat packet to the host computer. Thus, after receiving the heartbeat packet transmitted by the LIDAR, the host computer may determine whether the connection between the LIDAR and the host computer is normal according to the heartbeat packet.

At S502, when the transmission time of the next heartbeat packet is included in the heartbeat packet, the host computer receives the next heartbeat packet in the first predetermined time according to the transmission time of the next heartbeat packet.

The transmission time of the next heartbeat packet included in the heartbeat packet may be represented by at least two manners. For one manner, the transmission time of the next heartbeat packet may be directly the time that the LIDAR transmits the next heartbeat packet. For the other manner, the transmission time of the next heartbeat packet may be a time interval between the time that the LIDAR transmits the next heartbeat packet and the time that the LIDAR transmits the current heartbeat packet. Therefore, the transmission time of the next heartbeat packet may be determined according to the time interval between the time that the LIDAR transmits the next heartbeat packet and the time that the LIDAR transmits the current heartbeat packet.

The first predetermined time may be set according to the transmission time of the next heartbeat packet. For example, when the transmission time of the next heartbeat packet is represented by the time interval between the time that the LIDAR transmits the next heartbeat packet and the time that the LIDAR transmits the current heartbeat packet, and the time interval is 2 seconds, the first predetermined time may be set to 2.1 seconds, 2.2 seconds, 2.3 seconds, . . . , 4.9 seconds, or 5.0 seconds, which are described as examples in embodiments of the present disclosure. what the first predetermined time being set is not further limited by embodiments of the present disclosure.

At S503, if the host computer does not receive the next heartbeat packet in the first predetermined time, the host computer determines that the connection between the LIDAR and the host computer is abnormal.

In embodiments of the present disclosure, if the host computer does not receive the next heartbeat packet in the first predetermined time, the connection between the LIDAR and the host computer may be abnormal. On the contrary, if the host computer receives the next heartbeat packet in the first predetermined time, the connection between the LIDAR and the host computer may be normal.

In some embodiments, after determining that the connection between the LIDAR and the host computer is abnormal at S503, the method further includes the following process.

At S504, the host computer returns to execute the process of receiving the identification number of the LIDAR broadcasted by the LIDAR in the LAN.

Processes S501 to S504 describe how the host computer determines whether the connection between the LIDAR and the host computer is normal according to the heartbeat packet transmitted by the LIDAR. Correspondingly, after receiving the heartbeat packet transmitted by the LIDAR, the host computer may transmit the heartbeat return packet to the LIDAR, such that the LIDAR may determine whether the connection between the LIDAR and the host computer is normal according to the heartbeat return packet transmitted by the host computer with reference to the following processes S505 to S507.

At S505, the host computer transmits the heartbeat return packet to the LIDAR.

In embodiments of the present disclosure, no order exists between processes S502 to S504 and process S505. Processes S502 to S504 may be executed first, the process S505 may be executed, or process S505 may be executed first, and then processes S502 to S504 may be executed, or processes S502 to S504 and process S505 may be executed simultaneously. In embodiments of the present disclosure, processes S502 to S504 being executed first and then process S505 being executed is described as an example only. However, embodiments of the present disclosure may not be limited to this.

After receiving the heartbeat packet transmitted by the LIDAR, the host computer may transmit the corresponding heartbeat return packet to the LIDAR. As such, after receiving the heartbeat return packet transmitted by the host computer, the LIDAR may determine whether the connection between the LIDAR and the host computer is normal according to the heartbeat return packet.

At S506, if the LIDAR does not receive the heartbeat return packet in the second predetermined time, the LIDAR determines that the connection between the LIDAR and the host computer is abnormal.

The second predetermined time may be set in different manners. For example, when the time interval that the LIDAR transmits the heartbeat packet is two seconds, the second predetermined time may be set to 1.0 second, 1.1 seconds, 1.2 seconds, . . . , 4.9 seconds, or 5.0 seconds, which are described as examples in embodiments of the present disclosure. What the second predetermined time being set is not further limited by embodiments of the present disclosure.

In embodiments of the present disclosure, if the LIDAR does not receive the heartbeat return packet in the second predetermined time, the connection between the LIDAR and the host computer is abnormal. On the contrary, if the LIDAR receives the heartbeat return packet in the second predetermined time, the connection between the LIDAR and the host computer is normal.

When the time interval of the reception time of the heartbeat packet and the reception time of the last heartbeat packet is included in the heartbeat return packet, the LIDAR may determine whether a lost packet occurs according to the time interval of the reception time of the heartbeat packet and the reception time of the last heartbeat packet.

In some embodiments, after determining that the connection between the LIDAR and the host computer is abnormal at S506, the method further includes the following process.

At S507, the LIDAR returns to execute the process of broadcasting the identification number of the LIDAR in the LAN.

When determining that the connection between the LIDAR and the host computer is abnormal, the LIDAR may determine that the connection to the host computer may be disconnected. At this point, the LIDAR may enter the low power consumption mode and returns to execute process S201 of broadcasting the identification number of the LIDAR in the LAN. Correspondingly, the host computer may return to execute the process of receiving the identification number of the LIDAR broadcasted by the LIDAR in the LAN to try to re-establish the connection to the host computer. Therefore, the host computer may determine whether the connection between the LIDAR and the host computer is normal during the data transmission, and the LIDAR may determine whether the connection between the LIDAR and the host computer is normal through the heartbeat return packet to monitor the connection status of the LIDAR and the host computer.

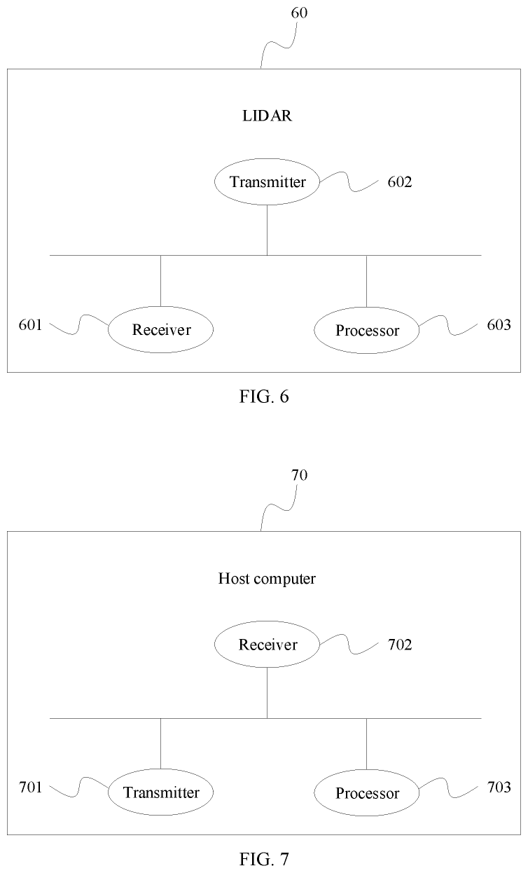

FIG. 6 is a schematic structural diagram of an LIDAR 60 according to some embodiments of the present disclosure. As shown in FIG. 6, the LIDAR 60 includes a receiver 601, a transmitter 602, and a processor 603.

The receiver 601 may be configured to receive the address information and the port identification of the host computer transmitted by the host computer.

The transmitter 602 may be configured to transmit the connection confirmation message. The connection confirmation message may be the ACK, which is used to indicate that the LIDAR 60 and the host computer are successfully connected.

The transmitter 602 may be further configured to transmit the data packet to the host computer according to the address information and the port identification of the host computer.

The processor 603 may be configured to determine whether the connection between the LIDAR and the host computer is normal through the heartbeat packet or the heartbeat return packet.

In some embodiments, the address information and the port identification of the host computer may be transmitted after the host computer receives the identification number of the LIDAR 60. The processor 603 may be further configured to broadcast the identification number of the LIDAR 60 in the LAN. The identification number has the one-to-one correspondence to the LIDAR 60.

In some embodiments, the receiver 601 may be further configured to receive the heartbeat packet transmitted by the host computer.

The processor 603 may be further configured to determine whether the connection between the LIDAR 60 and the host computer is normal according to the heartbeat packet transmitted by the host computer.

In some embodiments, the transmission time of the next heartbeat packet may be included in the heartbeat packet. The receiver 601 may be further configured to receive the next heartbeat packet in the first predetermined time according to the transmission time of the next heartbeat packet.

The processor 603 may be configured to, if the next heartbeat packet is not received in the first predetermined time, determine that the connection between the LIDAR 60 and the host computer is abnormal.

In some embodiments, the processor 603 may be further configured to return to execute the process of broadcasting the identification number of the LIDAR 60 in the LAN.

In some embodiments, the transmission time of the next heartbeat packet may be included in the heartbeat packet. The receiver 601 may be further configured to receive the next heartbeat packet in the first predetermined time according to the transmission time of the next heartbeat packet.

The processor 603 may be configured to, if the next heartbeat packet is received in the first predetermined time, determine that the connection between the LIDAR 60 and the host computer is normal.

In some embodiments, the transmitter 602 may be further configured to transmit the heartbeat return packet to the host computer.

In some embodiments, the transmitter 602 may be further configured to transmit the heartbeat packet to the host computer.

The receiver 601 may be further configured to receive the heartbeat packet transmitted by the host computer.

The processor 603 may be configured to determine whether the connection between the LIDAR 60 and the host computer is normal according to the heartbeat return packet transmitted by the host computer.

In some embodiments, the processor 603 may be configured to, if the heartbeat return packet is not received in the second predetermined time, determine the connection between the LIDAR 60 and the host computer is abnormal.

In some embodiments, the processor 603 may be configured to return to execute the process of broadcasting the identification number of the LIDAR 60 in the LAN.

In some embodiments, the processor 603 may be configured to, if the heartbeat return packet is received in the second predetermined time, determine the connection between the LIDAR 60 and the host computer is normal.

In some embodiments, the processor 603 may be further configured to stop broadcasting the identification number of the LIDAR 60.

In some embodiments, the processor 603 may be further configured to save the address information and the port identification of the host computer.

The LIDAR 60 may execute the technical solution of the method of monitoring the connection status of the LIDAR 60 on a LIDAR 60 side. The implementation principle and technical effect are similar, which are not repeated here.

FIG. 7 is a schematic structural diagram of a host computer 70 according to some embodiments of the present disclosure. As shown in FIG. 7, the host computer 70 includes a transmitter 701, a receiver 702, and a processor 703.

The transmitter 701 may be configured to transmit the address information and the port identification of the host computer 70 to the LIDAR.

The receiver 702 may be configured to receive the connection confirmation message transmitted by the LIDAR. The connection confirmation message may be the ACK, which may be used to indicate that the connection between the LIDAR and the host computer is successfully established.

The receiver 702 may be further configured to receive the data packet transmitted by the LIDAR. The data packet may be transmitted by the LIDAR according to the address information and the port identification of the host computer 70.

The processor 703 may be further configured to determine whether the connection between the LIDAR and the host computer 70 is normal through the heartbeat return packet or heartbeat packet.

In some embodiments, the address information and the port identification of the host computer 70 may be transmitted after the host computer 70 obtains the identification number of the LIDAR. The receiver 702 may be further configured to receive the identification number of the LIDAR broadcasted by the LIDAR in the LAN. The identification number has a one-to-one correspondence to the LIDAR.

In some embodiments, the transmitter 701 may be further configured to transmit the heartbeat packet to the LIDAR.

The receiver 702 may be further configured to receive the heartbeat return packet transmitted by the LIDAR.

The processor 703 may be configured to determine whether the connection between the LIDAR and the host computer 70 is normal according to the heartbeat return packet transmitted by the LIDAR.

In some embodiments, the processor 703 may be configured to, if the heartbeat return packet is not received in the second predetermined time, determine that the connection between the host computer 70 and the LIDAR is abnormal.

In some embodiments, the processor 703 may be further configured to return to execute the process of receiving the identification number of the LIDAR broadcasted by the LIDAR in the LAN.

In some embodiments, the processor 703 may be configured to, if the heartbeat return packet is received normally in the second predetermined time, determine that the connection between the LIDAR and the host computer 70 is normal.

In some embodiments, the receiver 702 may be further configured to receive the heartbeat packet transmitted by the LIDAR.

The processor 703 may be configured to determine whether the connection between the LIDAR and the host computer 70 is normal according to the heartbeat packet transmitted by the LIDAR.

In some embodiments, the transmission time of the next heartbeat packet may be included in the heartbeat packet.

The receiver 702 may be further configured to receive the next heartbeat packet in the first predetermined time according to the transmission time of the next heartbeat packet.

The processor 703 may be configured to, if the next heartbeat packet is not received in the first predetermined time, determine that the connection between the host computer 70 and the LIDAR is abnormal.

In some embodiments, the processor 703 may be further configured to return to execute the process of receiving the identification number of the LIDAR broadcasted by the LIDAR in the LAN.

In some embodiments, the transmission time of the next heartbeat packet may be included in the heartbeat packet.

The receiver 702 may be configured to receive the next heartbeat packet in the first predetermined time according to the transmission time of the next heartbeat packet.

The processor 703 may be configured to, if the next heartbeat packet is received in the first predetermined time, determine that the connection between the LIDAR and the host computer 70 is normal.

In some embodiments, the transmitter 701 may be further configured to transmit the heartbeat return packet to the LIDAR.

The host computer 70 may execute the technical solution of the method of monitoring the connection status of the LIDAR on a side of the host computer 70. The implementation principle and technical effect are similar, which are not repeated here.

Embodiments of the present disclosure further provide a computer-readable storage medium. The computer-readable storage medium may store a computer program. When the computer program is executed, the monitor method of the LIDAR connection status on the LIDAR side may be executed.

Embodiments of the present disclosure further provide a computer-readable storage medium. The computer-readable storage medium may store a computer program. When the computer program is executed, the monitor method of the LIDAR connection status on the host computer side may be executed.

Embodiments of the present disclosure are merely used to describe the technical solution of the present disclosure not to limit the present disclosure. Although the present disclosure is described in detail with reference to embodiments of the present disclosure, those of ordinary skill in the art should understand that modifications may be still made to the technical solution of embodiments of the present disclosure, or equivalent replacement may be performed on some or all technical features. All these modifications and replacements do not cause the essence of the related technical solution to depart from the scope of the technical solution of embodiments of the present disclosure.

What is claimed is:

1. A method of monitoring a connection status of a LIDAR comprising:
receiving address information and port identification of a host computer transmitted by the host computer;
transmitting a connection confirmation message to the host computer, the connection confirmation message being used to indicate that a connection between the LIDAR and the host computer is established successfully;
transmitting a data packet to the host computer according to the address information and the port identification of the host computer; and
determining whether the connection between the LIDAR and the host computer is normal through a heartbeat packet or a heartbeat return packet.

2. The method of claim 1, further comprising, before obtaining the address information and the port identification of the host computer transmitted by the host computer:
broadcasting an identification number of the LIDAR in a local area network (LAN), the identification number uniquely identifies the LIDAR;
wherein the address information and the port identification of the host computer is transmitted by the host computer after obtaining the identification number of the LIDAR.

3. The method of claim 1, wherein determining whether the connection between the LIDAR and the host computer is normal through the heartbeat packet includes:
receiving the heartbeat packet transmitted by the host computer; and
determining whether the connection between the LIDAR and the host computer is normal according to the heartbeat packet transmitted by the host computer.

4. The method of claim 3, wherein:
the heartbeat packet includes a transmission time of a next heartbeat packet; and
determining whether the connection between the LIDAR and the host computer is normal according to the heartbeat packet transmitted by the host computer includes:
in response to not receiving the next heartbeat packet in a predetermined time, determining that the connection between the LIDAR and the host computer is abnormal.

5. The method of claim 3, wherein:
the heartbeat packet includes a transmission time of a next heartbeat packet; and
determining whether the connection between the LIDAR and the host computer is normal according to the heartbeat packet transmitted by the host computer includes:
in response to receiving the next heartbeat packet in a predetermined time, determining that the connection between the LIDAR and the host computer is normal.

6. The method of claim 3, further comprising, after receiving the heartbeat packet transmitted by the host computer:
transmitting the heartbeat return packet to the host computer.

7. The method of claim 1, wherein determining whether the connection between the LIDAR and the host computer is normal through the heartbeat return packet includes:
transmitting the heartbeat packet to the host computer;
receiving the heartbeat return packet transmitted by the host computer; and
determining whether the connection between the LIDAR and the host computer is normal according to the heartbeat return packet transmitted by the host computer.

8. The method of claim 7, wherein determining whether the connection between the LIDAR and the host computer is normal according to the heartbeat return packet transmitted by the host computer includes:
in response to not receiving the heartbeat return packet in a predetermined time, determining that the connection between the LIDAR and the host computer is abnormal.

9. The method of claim 7, wherein determining whether the connection between the LIDAR and the host computer is normal according to the heartbeat return packet transmitted by the host computer includes:
in response to receiving the heartbeat return packet in a predetermined time, determining that the connection between the LIDAR and the host computer is normal.

10. The method of claim 1, further comprising, after receiving the address information and the port identification of the host computer transmitted by the host computer:
saving the address information and the port identification of the host computer.

11. A LIDAR comprising:
a receiver configured to receive address information and port identification of a host computer transmitted by the host computer;
a transmitter configured to:
transmit a connection confirmation message to the host computer, the connection confirmation message being used to indicate that a connection between the LIDAR and the host computer is established successfully; and
transmit a data packet to the host computer according to the address information and the port identification of the host computer; and
a processor configured to determine whether the connection between the LIDAR and the host computer is normal through a heartbeat packet or a heartbeat return packet.

12. The LIDAR of claim 11, wherein:
the processor is further configured to broadcast an identification number of the LIDAR in a local area network (LAN), the identification number uniquely identifying the LIDAR; and
the address information and the port identification of the host computer is transmitted by the host computer after obtaining the identification number of the LIDAR.

13. The LIDAR of claim 11, wherein:
the receiver is further configured to receive the heartbeat packet transmitted by the host computer; and
the processor is further configured to determine whether the connection between the LIDAR and the host computer is normal according to the heartbeat packet transmitted by the host computer.

14. The LIDAR of claim 13, wherein:
the heartbeat packet includes a transmission time of a next heartbeat packet; and
the processor is further configured to, in response to not receiving the next heartbeat packet in a predetermined time, determine that the connection between the LIDAR and the host computer is abnormal.

15. The LIDAR of claim 13, wherein:
the heartbeat packet includes a transmission time of a next heartbeat packet; and
the processor is further configured to, in response to receiving the next heartbeat packet in a predetermined time, determine that the connection between the LIDAR and the host computer is normal.

16. The LIDAR of claim 13, wherein the transmitter is further configured to transmit the heartbeat return packet to the host computer.

17. The LIDAR of claim 11, wherein:
the transmitter is further configured to transmit the heartbeat packet to the host computer;
the receiver is further configured to receive the heartbeat return packet transmitted by the host computer; and
the processor is further configured to determine whether the connection between the LIDAR and the host computer is normal according to the heartbeat return packet transmitted by the host computer.

18. The LIDAR of claim 17, wherein:
the processor is configured to, in response to not receiving the heartbeat return packet in a predetermined time, determine that the connection between the LIDAR and the host computer is abnormal.

19. The LIDAR of claim 17, wherein:
the processor is configured to, in response to receiving the heartbeat return packet in a predetermined time, determine that the connection between the LIDAR and the host computer is normal.

20. The method of claim 11, wherein the processor is further configured to save the address information and the port identification of the host computer.
